(19) United States
(12) Patent Application Publication
(10) Pub. No.: US 2011/0098669 A1
(43) Pub. Date: Apr. 28, 2011

(54) Intravenous spike holder for easier penetration of sealed intravenous bag

(76) Inventor: George R. Boyes, Mount Hope (CA)

(21) Appl. No.: 12/589,473

(22) Filed: Oct. 26, 2009

(51) Int. Cl. A61J 1/14

(52) U.S. Cl. 604/411

(57) ABSTRACT

An aid to assist in using a standard spiking device for puncturing an intravenous bag which has not been previously opened. The aid consists of a round handle in which a cavity is formed, to receive the spiking device therein. The handle is provided with a slot so that the tube which is part of the spiking device may fit into the slot, and the spiking device may now fit precisely into the handle.

The handle is provided with a protective lip at one end so that the user is protected from injury during the bag puncturing operation. This device helps prevent repetitive strain injury caused by the constant opening of intravenous bags by hospital personnel.

The present invention relates to an device which is fitted to a spiking device which is used to puncture intravenous bags (such as may be used in a hospital setting) at a point provided on the intravenous bag and which enables the user to puncture the intravenous bag with relative ease (whilst maintaining the point of puncture sterile) because of lessening the effort and manual dexterity required to puncture the intravenous bag.

Intravenous bags have continuously developed over the years. It is not by accident that the bags as they presently exist are easy to print on, are transparent, and hermetically sealed, tough, and flexible, with a hanging facility located at one end of the bag and at least one puncture assembly (for intravenous use) located at the opposite end of the bag. It is important that these intravenous bags lend themselves to being roughly handled, are capable of being opened quickly and easily in a sterile manner.

Simultaneously, intravenous spiking devices were evolving and developing to be used in association with the above described intravenous bags. Above all else, the point of entry of the spike into the bag must be done in a sterile manner. To accomplish this, the intravenous bag is provided with at least one appendage (located at the opposite end of the bag from the hanging facility) which is provided with a recessed membrane seal which a sharp spike is able to puncture and penetrate with relative ease. The membrane seal is located within the interior of the appendage where it is protected from accidental rupture. This system has functioned well in the past. The intravenous bag is penetrated by the spiking device and the contents of the bag are transferred to a patient by a tubing arrangement, the flow of which is controlled in a regulated manner and which is connected to the spiking device which is left in place where it has sterilely punctured the intravenous bag.

The action of puncturing the seal on the intravenous bag with a spiking device is repeated as often as one intravenous bag is emptied and it is deemed necessary for the patient's well being to continue the intravenous treatment. All this happens each time new intravenous bags are substituted for old depleted ones and/or new patients are connected to similar apparatus.

It is to this end that the present invention was conceived. Because it is repeated so often, the action of puncturing the membrane in a new bag with a spike can be lead to repetitive strain injury (RSI) of the person carrying out the procedure, if the procedure is done often enough.

This invention relates to an adapter which is provided with an opening extending the length of the adaptor to accept the spike device and associated tubing so that the puncturing of the intravenous bag is carried out with relative ease using the spike holder adapter. The adaptor may be formed in any number of ways; it may be formed from a relatively stiff material such as ABS plastic, or it may be formed from a flexible material such as a PVC plastic material. It may also be formed from a metallic material. Of course the adapter will generally be molded when a quantity of such devices are produced.

Thus when it is desired to use this device, one has only to fit the end of the spike device and its associated tubing into the adaptor about which this invention is concerned, remove the protective cover from both the spike device and the appendage which forms part of the intravenous bag to expose both the sharp point of the spike and the seal located in the interior of the appendage on the intravenous bag. After this has been done the sharp spike of the spike device is inserted into the seal located in the aforementioned appendage to puncture the seal, and then the spike device is pushed home in the appendage, to connect contents of the intravenous bag to the connecting intravenous tubing of existing equipment, or to a new patient whichever is the case.

### BRIEF DESCRIPTION OF THE DRAWINGS

FIG. 1 shows a perspective of an intravenous bag used with this invention.

FIG. 2 is a perspective view of the puncturable seal of the intravenous bag shown in FIG. 1.

FIG. 3 is a perspective sectional view of the cover cap applied to the appendage shown in FIG. 2.

FIG. 4 shows a perspective view of a spiking device and the intravenous tubing forming a part thereof.

FIG. 5 shows an adaptor of this invention.

FIG. 6 shows the adapter, associated spike and intravenous tubing inserted therein ready for the operation of puncturing the seal in the intravenous bag.

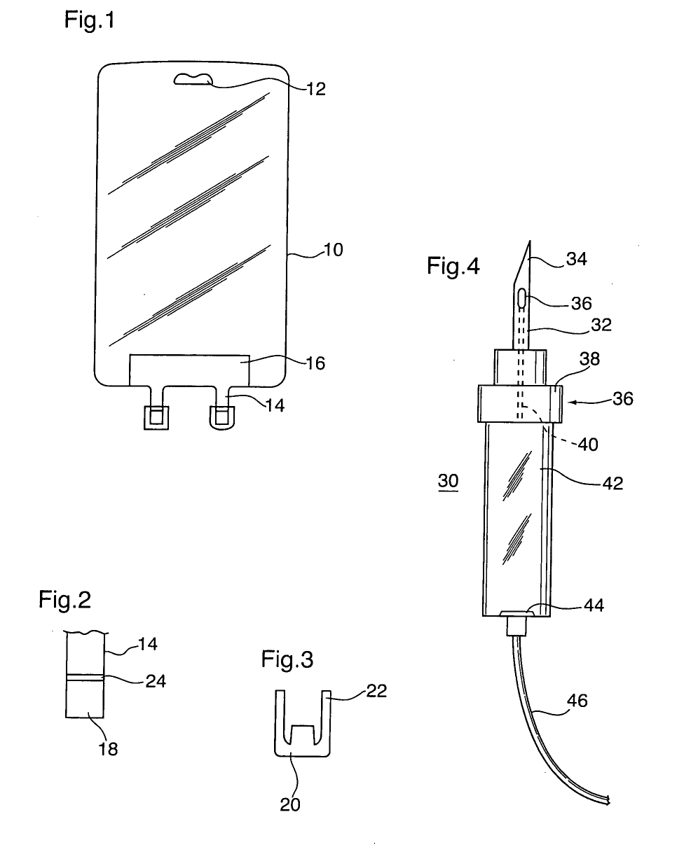

Referring to FIG. 1 an intravenous bag 10 is shown, being manufactured from a tough flexible plastic material which is transparent to reveal the contents thereof. It will be labeled on the outside surface so that the operator will know what the contents contained therein are and the user can see that they have not been emptied.

At or near one end thereof of bag 10 is provided a hanging facility 12 so that intravenous bag 10 may be fastened or hung on a pole device (not shown). On the end of bag 10 remote from the hanging facility 12, is located at least one and possibly two appendages 14. The appendages 14 will usually be formed from a material 16 that is welded to or otherwise formed in the bag 10. This is a separate material 16 as distinct from the material forming the intravenous bag 10. The material 16 will generally be of a plastic material that is softer in nature than that of the intravenous bag 10.

Upon closer examination of one of the appendages 14, it will be noted that the appendage is closed to the elements at the end 18 thereof by stopper 20 (see FIG. 3) and its integrally attached sleeve 22. Removing the stopper 20 requires that sleeve 22 of stopper 20 must be removed from appendage 14 as well. Further examination of appendage 14 reveals a recessed seal 24 disposed in the interior 20 of the appendage 14. The seal 24 comprises a puncturable membrane 22 which is integrally formed in the material forming the appendage 14.

If a second appendage is formed in the bag 10 it will be constructed in a similar manner to the appendage just described.

Referring now to FIG. 4, a spiking apparatus 30 is shown. Spiking apparatus 30 comprises a plastic end 32 which is provided with a sharp spike tip 34 for puncturing the seal 24 in bag 10. The device 30 is somewhat elongated and is provided with a suitable housing 36 for the accommodation of integrally formed spike 32 thereon. Housing 42 is somewhat enlarged at 38 to accommodate the integral fastening of chamber 38 and provide a suitable enlargement for manually grasping the member 30 during the seal insertion process, as well as priming the fluid to be introduced into the tubing 46.

It is this operation that this invention is directed, and a generous amount of care must be taken here. The end of spike 32, that is spike tip 34 (which intentionally is made to be sharp) may be composed of a suitable plastic or other metallic material and is sealingly fitted onto a chamber device 42. The spike 32 is provided with one or more apertures 36 near the spike tip 34 of spike 32 which are in communication with the internal passageway 40 of device 30. Passageway 40 leads and empties into chamber 42 of device 30. In the bottom of chamber 42 is an adaptor 44 on which tube 46 is fitted. Tube 46 passes though a series of accessories to a patient receiving fluid contained in bag 10.

The problem of puncturing the seal 24 with the spike 32 will be addressed. Conventionally, the entire end of the apparatus 30 bearing spike tip 34 will be applied to seal 24. This means that bag 10 is firmly grasped in one hand at appendage 14 whilst the other hand grasps the puncturing assembly 30. Point 34 is now pressed against seal 24 until seal 24 ruptures and at this point the spike 32 is pushed home. Spike 32 now has entered the appendage 14 so that the apertures 36 are now located beyond the seal 24 and are immersed in the treatment liquid contained in bag 10. Spike 32 is now ready to drain the contents of the bag 10 into the chamber 34 and on to the tube 44 which will inject the fluid contained in bag 10 into the patient.

Because this process is repeated many times during a hospital shift, care must be exercised when the puncturing operation is being carried out. First there is always the danger that the spike 32 may, for some reason, slip and injure the operator.

Then there is a problem which has become known as ‘repetitive strain injury” (RSI) caused by doing the same task over and over again. It is to relieve these problems that this invention is directed.

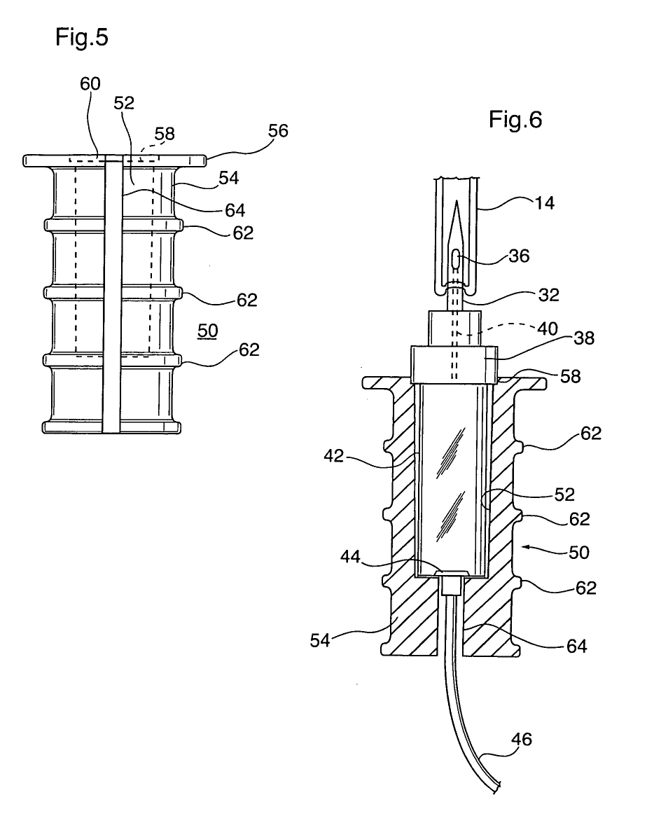

The solution to solving these problems lies in the device shown in FIG. 5. Here a handle device 50 is shown which holds the device 30 in a cavity matched to the exterior of the device 30 as shown in FIG. 4. The device 50 consists of a housing 52 which is usually made from a material, such as a plastic. Although other materials could be used applicant prefers to use a plastic substance for this purpose. Housing 52 contains a chamber 54 which is matched to chamber 42 of device 30. Handle device 50 is also supplied with a protective rim or lip 56 which encircles the end 60 of the handle. This protects the hand of the user while the sharp spike 38 is being unwrapped and is inserted into bag 10 by piercing seal 24. Protective rim or lip 56 also serves as a convenient guide to enable the user to tell when the device 30 has been correctly installed in handle device 50 without any visual investigation.

Handle device 50 is also provided with a series of spaced parallel rings 62 in order to improve the grip of the handle 50 during use.

Handle device 50 is provided with a slot 64 which serves as a convenient access to the interior of handle 50. The spiking device 30 is inserted into handle 50 by first locating the tube 46 of the spiking device 30. Tube 46 is then inserted into slot 64 of handle 50. When this is done device 30 is pulled into chamber 52 of handle 50. Chamber 42 fits neatly within chamber 52 of handle 50.

Next, enlargement 38 of spiking device 30 is pulled into chamber 58 of handle 50 signifying that the spiking device 30 is correctly installed in the handle 50 and the spiking operation with a intravenous bag may begin.

Spike 32 will now be held firmly and precisely in handle 20 and now the force required to pierce seal 24 using the spike tip 34 will appear to be substantially reduced because the force is distributed over a larger area. This will lead to a substantial reduction of RSI injuries that would have been suffered by the persons installing the intravenous bags.

1. A handle device for assisting in puncturing a seal in a standard intravenous bag comprising:
a handle of elongated nature and of such shape as to be conveniently grasped by the human hand,
said handle having a top and a bottom wherein a lip is formed at the top of said handle,
said handle having a cavity formed therein for receiving a standard spiking device therein,
said handle having a slot formed therein which extends from the top to the bottom of said handle.

2. A handle as claimed in claim 1 which is a solid of revolution.

3. A handle as claimed in claim 2 wherein said slot is of such size that it conveniently accepts a standard tube of a standard spiking device.

4. A handle device as claimed in claim 3 wherein said cavity matches the shape of the standard spiking device.

5. A handle of claim 4 wherein said handle has a recess in top surface thereof for accepting and indicating that the standard spiking device has been correctly inserted in said handle.

6. A handle as claimed in claim 5 wherein said handle is provided with spaced projections on said handle.

7. A handle device for accepting therein a standard intravenous bag spiking device in a cavity formed within said handle,
said handle having a slot formed therein which extends the length of said handle and is in communication with said cavity,
said handle being of a size to be conveniently grasped by the hand,
said handle having a protective lip formed at one end thereof,
said handle having a series of spaced rings formed therein.

8. A handle as claimed in claim 7 wherein said handle contains a circular recess which is located in the end of the handle adjacent said lip

9. The method of using a handle device for assisting in the puncturing of a standard intravenous bag comprising:
supplying a standard sealed intravenous bag having at least one protruding appendage having a seal located therein,
supplying a standard spiking device comprising a sharp spike integrally attached to and which has a passage in communication with a boss member which in turn is sealingly attached to a hollow chamber which is in communication with an elongated tube extending from said hollow chamber,
supplying a handle device which has a slot extending the length of said handle device, said handle device having a cavity formed therein which conveniently accepts said spiking device, said slot being in communication with said cavity,
inserting said tube into said handle device in said slot therein,
and inserting said spiking device into said cavity in said handle,
and puncturing said seal in said appendage in said bag with said standard spiking device,
and removing said handle from said standard spiking device.

10. A method as claimed in claim 9 wherein said handle has a projecting lip formed in one end thereof.

11. A method as claimed in claim 10 wherein said handle has a recess formed therein adjacent the lip for receiving said boss therein.
